(19) United States
(12) Patent Application Publication
(10) Pub. No.: US 2017/0352050 A1
(43) Pub. Date: Dec. 7, 2017

(54) MEETING MANAGEMENT SYSTEM AND PROCESS

(71) Applicant: David NIXON, Freshwater (AU)

(72) Inventor: David NIXON, Freshwater (AU)

(21) Appl. No.: 15/613,598

(22) Filed: Jun. 5, 2017

(30) Foreign Application Priority Data
Jun. 7, 2016 (AU) 2016902220

(51) Int. Cl. G06Q 30/02; G06F 3/0482; G06F 17/30

(52) U.S. Cl. CPC G06Q 30/0218; G06F 17/30002; G06F 3/0482; G06F 17/30

(57) ABSTRACT

A system for managing a meeting, comprising: a server adapted for storing at least one data set. The server in communication with at least one user device, in which the system is adapted to receive at least one input from at least one user for upload to the server. The input generates at least one further data set which is assigned to at least one thread of a discussion automatically by the server in which each of the at least one threads relate to a respective discussion. The at least one thread comprises at least one comment and wherein the system is adapted to output a graphical display for at least a portion of the discussion based on the at least one input from the at least one user device. In this way when a further thread for a discussion is input, the system generates a further thread for the discussion.

Australian Provisional Application No. 2016902220, filed on Jun. 7, 2016, is incorporated herein by reference in its entirety.

### TECHNICAL FIELD

The present invention relates to a management system and/or process for a meeting or conference. More particularly, the system allows for aspects of a meeting to be collated, summarised and ratified based on meeting participant input.

### BACKGROUND

Businesses and committees, such as groups participating in community consultation or democracy exercises, are routinely required to attend meetings or conferences to discuss issues or discuss important topics. The typical goal of meetings is to achieve a potential solution to said issues, or resolve important discussion topics. However, while resolution to issues is typically a goal for meetings, this is not always achieved.

Commonly, meetings can divert from the issue or topic at hand and result in wasted time and issues continue to exist without a proposed solution or resolution. This can cause unnecessary delays and may result in additional expenditure due to mismanaged time.

In addition, it may also be difficult to have all desirable members for a meeting in a single location, have a common time in which all desirable members can meet. This can further cause delays to important projects or delay potential resolutions to outstanding issues.

While there are some known Voice over Internet Protocol (VoW) services which provide the ability to conduct a meeting from a number of different locations, such as Skype™ or Google Hangouts™, these systems require the members of the meeting to be online at the same relative time. These systems also have the traditional problems of conversations becoming side-tracked or may result in no clear resolution to an issue. Namely, conversations are not typically focused and are often difficult to summarise accurately or reach a consensus.

A further problem with traditional meetings is that members of the meeting may be overly verbose or focus on irrelevant issues which can result with a delay in finding a potential resolution for the issue or topic in the meeting. Further, it is difficult to manage the duration of a meeting and it becomes difficult to provide a comprehensive succinct summary of discussed issues and/or topics.

Any discussion of the prior art throughout the specification should in no way be considered as an admission that such prior art is widely known or forms part of common general knowledge in the field.

### SUMMARY

### Problems to be Solved

It may be advantageous to provide a system or method for a meeting which allows members of the meeting to attend at relatively different times.

It may be advantageous to provide a meeting system or method which encourages members of a meeting to produce a potential resolution or potential problem to an issue raised in a meeting.

It may be advantageous to provide a meeting system or method adapted to rule out potential solutions to an issue based on feasibility.

It may be advantageous to provide a meeting system or method adapted to rule out potential solutions to an issue based on at least one rule.

It may be an advantage to provide a system or method to identify logical relationships between solutions of meetings.

It may be an advantage to provide a system or method for enticing an individual to provide a suggestion for a solution and/or provide a summary for a meeting thread or agenda.

It may be an advantage to provide a system or method for a meeting which allows a meeting to happen not in real time.

It may be an advantage to provide a system or method for a meeting which provides a reward or incentive for providing constructive comments or providing a summary.

It may be an advantage to provide a system or method for a meeting which provides a reward or incentive for reducing the total amount of audio and/or video of a conversation for a summary.

It may be advantageous to provide a system to nudge members of a meeting to produce a potential solution or arrive at a resolution for a meeting thread.

It may be an advantage to provide a system which allows a meeting to progress without the need for a facilitator.

It is an object of the present invention to overcome or ameliorate at least one of the disadvantages of the prior art, or to provide a useful alternative.

### Means for Solving the Problem

In one aspect of the present disclosure there may be provided a system for managing a meeting. The system comprising a server adapted for storing at least one data set. The server may be in communication with at least one user device, in which the system may be adapted to receive at least one input from at least one user for upload to the server. The input may generate at least one further data set which may be assigned to at least one thread of a discussion automatically by the server in which each of the at least one threads relate to a respective discussion. The at least one thread preferably comprises at least one comment, and wherein the system may be adapted to output a graphical display for at least a portion of the discussion based on the at least one input from the at least one user device, such that when a further thread for a discussion may be input, the system may generate a further thread for the discussion.

In one embodiment, the input from the at least one user device comprises at least one of; a further comment, a like, a dislike, and a vote. Preferably, at least one of the comment and the further comment comprises at least one of; audio data, video data, text data, images data, at least one document data set, and a web address. Preferably, each comment comprises at least one context item. Preferably, the system may be adapted to generate at least one track for a thread when a comment may be made by a user for a discussion. Preferably, the discussion may be at least one of the group; a meeting, a conference, a poll, a forum and a convention. Preferably, the system uses a template to assign data for the graphical display of at least a portion of the discussion. Preferably, the template may be a custom template generated by at least one user of the system. Preferably, the system generates a value associated with a comment. Preferably, the value may be at least one of a tax and a reward, which may be generated based on at least one of; a number of comments in the discussion, a length of the discussion and a level of agreement in the discussion. Preferably, a context item may be a data set associated with at least one comment which comprises data which may be related to at least one of a goal, a proposal, evidence and a meeting specific data set.

In another aspect of the present disclosure, there may be provided a system for managing a discussion. The system comprising a data set stored on a sever relating to a discussion for an issue, in which the discussion comprises at least one thread. The at least one thread comprising at least one comment generated by at least one user of the system; and wherein the system may be adapted to output a graphical display for at least a portion of the discussion based on the at least one input from the at least one user device, such that when a further thread of discussion may be input, the system generates a further thread for the further thread of discussion.

In one embodiment, the system preferably generates at least one of a virtual tax and a virtual reward for generating a comment. Preferably, at least one of a virtual tax and a virtual reward may be generated based on at least one context item associated with the discussion. Preferably, a comment can be associated with at least one context item. Preferably, the system provides an incentive to generate a constructive comment for a discussion. Preferably, a comment comprises at least one of audio data, video data, text data, images data, at least one document data set, and a web address. Preferably, the at least one user of the system may be provided with an incentive to generate a summary for at least a part of the discussion. Preferably, the incentive may be at least one of; currency, virtual currency, talk time, number of comments available to be generated or access to a further meeting. Preferably, the discussion may not be in real time.

In the context of the present disclosure, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present disclosure aims to solve or ameliorate at least one of the technical problems and this may result in one or more advantageous effects as defined by this specification and described in detail with reference to the preferred embodiments of the present disclosure.

### BRIEF DESCRIPTION OF THE FIGURES

FIG. 1 illustrates schematic of an embodiment of the meeting management system;

FIG. 2 illustrates a diagram of an embodiment of a conversion process of the meeting management system;

FIG. 3 illustrates a diagram of an embodiment of comment data which may be associated with a database of the meeting management system;

FIG. 4 illustrates a flowchart of an embodiment of the conversion structure builder of the present disclosure;

FIG. 5 illustrates a flowchart of an embodiment of the of a price and reward system of the meeting management system;

FIG. 6 illustrates a flowchart of an embodiment of a conversation visualiser of the meeting management system;

FIG. 7 illustrates a flowchart of an embodiment of a comment player adapted for use with the meeting management system;

FIG. 8 illustrates a flowchart of an embodiment of a secure comment extractor adapted for use with the meeting management system;

FIG. 9 illustrates a flowchart of an embodiment of a vote processor adapted for use with the meeting management system;

FIG. 10 illustrates a flowchart of an embodiment of a comment recorder adapted for use with the meeting management system;

FIG. 11 illustrates a flowchart of an embodiment of a comment upload of the meeting management system;

FIG. 12 illustrates a flowchart of an embodiment of a structure questionnaire adapted for use with the meeting management system;

FIG. 13 illustrates a flowchart of an embodiment of a context visualiser adapted for use with the meeting management system;

FIG. 14 illustrates an embodiment of a new comment screen displayed by the meeting management system; and

FIG. 15 illustrates an embodiment of a conversation or meeting with a plurality of threads displayed by the meeting management system.

### DETAILED DESCRIPTION

Preferred embodiments of the invention will now be described with reference to the accompanying drawings and non-limiting examples.

The present disclosure is directed towards a meeting management system, herein referred to as “the system”. The system is preferably adapted to keep discussions, threads or ideas raised during a meeting separated, or may be adapted to discontinue threads of a discussion raised which are not relevant or impractical to the thread of the meeting. In one further embodiment, this disclosure is directed towards a process or a device to accomplish the same or additional steps.

The system may also be adapted to encourage members of the meeting to arrive at one or more solutions or potential resolutions to at least one issue for discussion during the meeting. Further, the system may also be adapted to entice members of a meeting to summarise a thread of discussion, such that a consensus or potential resolution may be agreed upon. Throughout this specification, a “member of a meeting” may be referred to as a “user”.

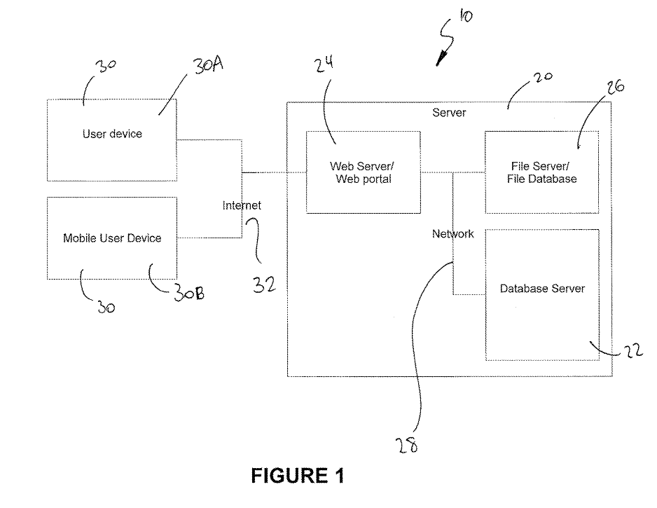

Referring to FIG. 1 there is depicted an embodiment of the meeting management system 10. The system 10 is preferably hosted on a server 20 which is adapted to store at least one data set and/or execute at least one program. Data may be stored in a storage means associated with the server and may be stored in partitions of said storage means. Partitions of the server may be for example; a database server 22, a web server 24, and a file server 26, and may be in communication via a network 28 connection. The web server preferably comprises at least one application for allowing a conversation and at least one application for a web site.

The file server 26 of the system may be adapted to store data such as files, confidential information and attachments. Preferably, the data stored by the system encrypts the data such that the data uploaded or associated with the system remains confidential. Any suitable encryption algorithms or processes may be used by the system to reduce the potential for data to be accessed by unauthorised persons. For example, the system may employ a key system with a private key 70 and a public key associated with at least one user. The private key 70 is preferably only held by a single person or entity and a public key may be publically displayed, at least for a predetermined period of time.

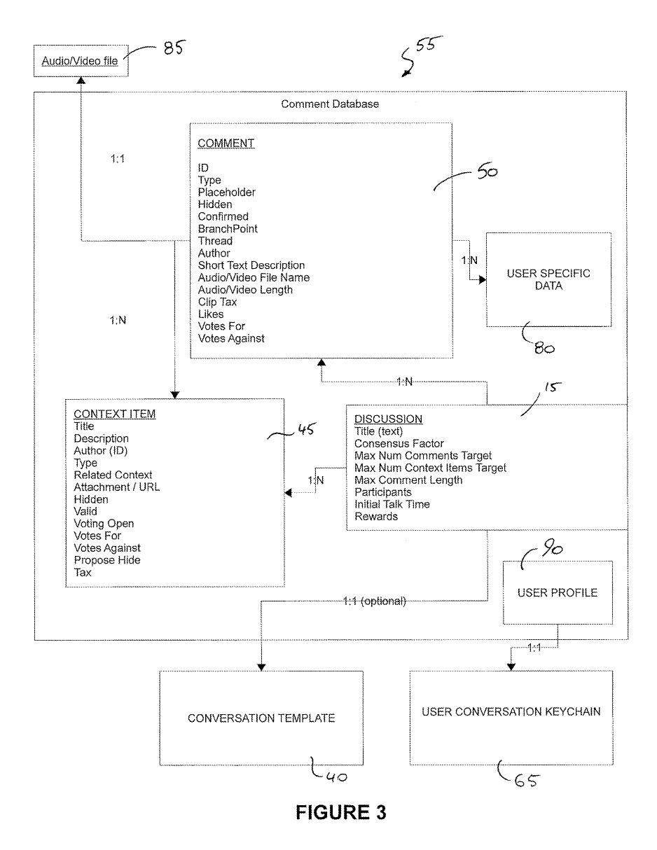

The database of the system 10 is adapted to store data sets related to at least one of; organisations (organizations), users, user profiles, conversations, meetings, conferences, templates and any other predetermined data sets. The user profiles will typically comprise personal information, conversation history, keys (such as encrypted keys, private keys or public keys), audio and/or video files and message history. It will be appreciated that private keys are preferably not stored on the server, and the private key will be sent to a user for a predetermined use or period of time. After the predetermined use of the private key, the private key may be deleted or otherwise destroyed, however a copy of the private key is retained by the user. A user profile 90 (refer to FIG. 3) may also be assigned with a user profile picture which allows other users to identify the user, typically is a user profile user name is a pseudonym or other fictitious name which does not correspond to a user's or member's legal name. The system may further be adapted to utilise PGP (pretty good protocol) keys or the like.

The keys associated with a user profile 90 may be stored in a user conversation keychain 65 or a “key collector box”, which stores keys associated with a user profile. The keys may be keys to meetings the user is associated with or keys for confirming an identity or the like. Preferably, a public key is used to encrypt and deposit shared conversation keys in the keycollector box. The comments generated by a user can be encrypted using a shared conversation key. Any predetermined cryptographic function or cryptographic algorithm may be used to encrypt comments.

The conversation templates 40, also referred to as discussion templates 40, may define the visual aspects of a meeting's discussion, and may also define how comments are linked to one another. The template 40 can also have at least one rule assigned thereto or associated with which can govern access to a discussion, requirements for comments or threads and may also restrict types of comments from being made, such as comments containing vulgar or unsavoury language. Discussion templates may be customised by at least one user of a system such that the graphical representations displayed to a user of the system can be controlled, manipulated or otherwise presented in a desirable format.

At least one client device 30 (also referred to herein as a ‘user device’) can communicate with the server of the system. A client device can be a user device 30A or mobile user device 30B, for example, at least one of the group of; a computer, a laptop, a tablet computer, a mobile device, a cellular device, a smart phone, a web portal or the like. For example, if the device is a computer it will be adapted to access a web browser, typically via the internet 32, such that data can be uploaded to the system and the system may send at least one data set to the computer. The client device preferably has a microphone or audio capture means to record data which may be optionally uploaded to the system. Optionally, the client device 30 will further comprise a capture device, such as a camera or video recorder to take at least one image or capture a series of images which may be suitable to be uploaded to the system. In one embodiment, the client device 30 may only be adapted to receive messages for viewing via a display and may not be required to have an audio capture device or an image capture device, but will preferably be adapted to receive an input from a user of the client device. The client device 30 may also comprise a speaker means or be adapted for use with headphones.

In another example, an application (“app”) may be installed on a smart phone or mobile device which allows the smart phone to communicate with the system 10. It will be appreciated that an app may be installed or associated with any suitable client device 30, such as a computer, laptop or the like to allow for communication with the system 10. The smart phone or mobile device comprises a storage means to store at least one data set, such as cookies and audio files.

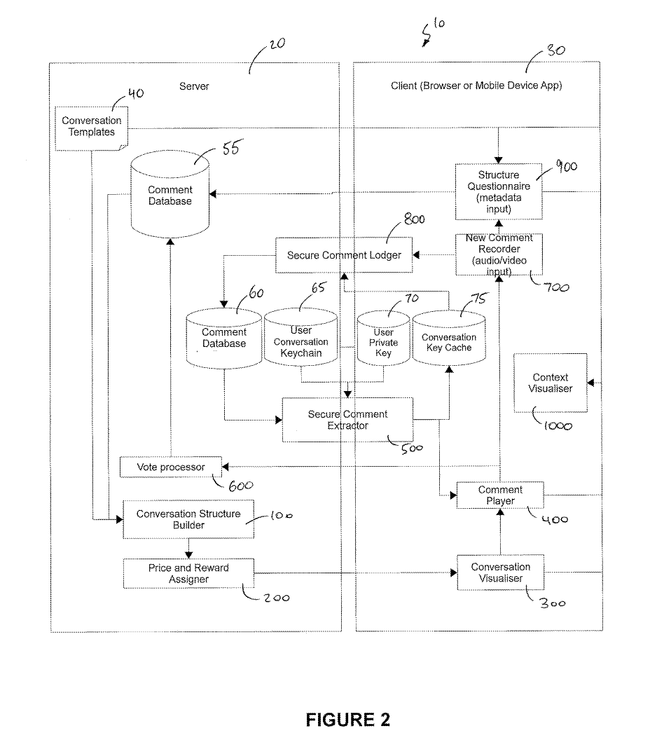

Referring to FIG. 2, there is shown an embodiment of the meeting management system 10. The server of the system 10 comprises at least one conversation template 40 which assists with managing the meeting such that data is input into at least one predetermined field. Conversation templates 40 for use with a meeting are optional, and more than one conversation template 40 may be used for managing a meeting. If conversation templates 40 are not required by a user, the system 10 may be adapted to assess data input into the system 10 and automatically assign the data to at least one predetermined field such that a graphical representation can be generated by the system 10. Fields may be used to separate and/or classify data which is input into the system to assist with keeping threads of a discussion 15 separated such that all comments that apply to a particular thread are grouped together. Preferably, the comments made for a thread are grouped in a linear progression such that a discussion can progress in a typically understandable manner for a person reviewing a discussion thread of a meeting.

The database server 22 or file server 26 may further comprise a comment database 55, which is adapted to store comment data associated with at least one meeting. The comment data, or comments 50, are associated with data and/or metadata. Metadata may include an identification marker for the comment 50, which is preferably a unique identification marker such that the system may differentiate between stored comments 50. Further a comment may be associated with a context item which may then be associated with preferably only one open discussion at a time.

The comment 50 may further comprise a type identifier used to identify the context of the comment. The context of the comment 50 may be identified with a type identifier such as; a comment, agreement, disagreement, question, answer, summary, closure or any other predetermined type identifier. A place holder may be a type of comment which is generated and assigned predetermined attribute values, such as a type identifier, prior to a first comment being generated by a user. The member of a meeting may be required to complete the placeholder comment prior to generating a further comment. The place holder may be a comment which is used to encourage a member of a meeting or user of the system to follow a predetermined sequence of interactions with others, such as to introduce themselves first. A user may have a default or preferred message or data set to assign to a placeholder comment without direct input from the user. Other place holder comments may be used by the system. Comments may be hidden or confirmed as separate fields.

A comment may also be assigned a branch attribute. The branch attribute may be adapted to start a new thread or a related thread for a discussion in a meeting. If a comment is assigned a branch attribute, the comment is preferably the first comment in the new thread. A branch may be identified as relevant or non-relevant to a meeting, such that only relevant branched of discussion are continued to ensure that the meeting is kept on track. A thread identification may also be assigned to a comment, adapted to track each thread of the meeting and link new comments to existing threads or generate a new thread for new comments with no existing relevant thread.

Other data may also be assigned to a comment 50, such as an author identification, audio and/or video data, tax of the comment, a short text description, reward for placing a comment, a number of likes or upvotes, a number of dislikes or downvotes, votes for and votes against. It will be appreciated that only at least one predetermined data set exemplified may be assigned to a comment. The comment may further be associated with an audio/video file 85.

Some markers may be assigned to a comment and may be assigned by users of the system 10. A marker may be a data set which corresponds to an input from a user. For example, a marker, such as a vote for or against, for a comment can be assigned objectively or subjectively by another member of a meeting or by an authorised user of the system. Other user specific data may be assigned to a comment, such as a user profile picture for other users to identify the user who generated the comment, a bookmark such that a user can easily identify important comments or tag a comment, a marker to indicate whether or not a comment has been listened to or viewed by a user profile.

Conversations may comprise data including; titles, a consensus factor, a predetermined maximum number of allowable comments, a maximum allowable comment length, a maximum allowable content length, a maximum number of context items target, a maximum or minimum number of participants for a meeting, an initial talk time, a reward or any other predetermined data set. The terms “conversation” and “discussion” are used interchangeably throughout this specification.

The calculated degree of consensus may be determined based on a percentage score relative to the number of users and the likes compared with dislikes. A consensus factor may be a preconfigured threshold is not a calculation. For example, if there are ten users, and nine of the ten users have cast a vote, with two users disliking the comment and seven users liking the comment resulting in a 78% approval rating (7/9=78%), the consensus for the comment is that the majority of the users of the system approve the comment made by a user and a calculated degree of consensus is made that the comment is approved or agreed upon. A predetermined threshold must be exceeded for a consensus for a comment, for example, a consensus may be at least 70% for approval for a consensus to be reached. It will be appreciated that a consensus factor may be dynamically applied based on the number of members of a meeting.

Further, exclusions may be applied by the system based on a historic voting record of a member of a meeting. The exclusion may be a factor of time and voting history, such that members of a meeting who immediately downvote or consistently disagree with a particular member of a meeting may have their vote excluded when calculating a degree of consensus. This may assist with progressing a meeting and reduce the potential for an outside bias to impact a meeting decision, for example if one member of a meeting dislikes another member of a meeting. However, it will be appreciated that if the majority of members of a meeting also consistently downvote or disagree with a member of a meeting that the votes may not incur an exclusion. At least one data set may be assigned to a user profile for at least one conversation which can force the system to restrict or prohibit comments made by a user, or voting made by the user.

In a further embodiment, a maximum comment length may be in seconds for audio or video comments or number of characters allowable, or a combination thereof. A maximum content length may also be based on an allowance balance of the user, such that a maximum comment length is determined based on the allowance balance of the user rather than a fixed predetermined limit.

A context item 45 may be a related to a comment 50 which may include text and/or audio and/or video data. The context item may also be assigned at least one data set, for example; a title of the context item, a description, an author or author ID, a type of context item, a related context item (if there is a context item relationship), an attachment, an attribute (such as whether the context item is hidden), a validity marker, a voting status, a number of votes, a tax, a reward, a proposition, or any other predetermined data set. Preferably a user can suggest to hide a context item and collect a reward if a consensus to hide the context item is agreed upon.

An attachment may include; video data, audio data, a file, a document, an image, a URL, a web address, an address, an IP address, meta data or any other data which may form an attachment. A validity marker may be used to show what the group thought of the context item or relationship, or what the author of a comment thinks of the context item or relationship. A value of a validity marker may be a title such as ‘valid’, ‘invalid’ or ‘undecided’.

Optionally, the conversation for a meeting may be assigned a conversation template. The conversation template may dictate rules or thresholds which the members of a meeting may be required to abide by. For example, comments with slander and/or profanities may be censored or excluded. Other rules may include, for example, maximum length of comments or allowable comment threads. In yet another embodiment the system may allow a member of a meeting and/or an authorised person to generate a custom conversation template. Preferably a template is used such that rules are predetermined for discussions, and further placeholder comments with predetermined titles, type values and author details may be assigned. Rules may define the types of comments which may be generated, how comments may be associated with context items, how threads are formed, how comments relate to the overall discussion or any other predetermined rule. Rules may be triggered based on previous rules. For example, triggering rule 1 must occur before rule 2 is enacted by the system. In a further example, rules may be enacted or triggered from a logical state of fields in a comment (or thread, or discussion), such as whether place holder has a “YES” or “NO” value, if a thread is closed, or if a discussion is closed.

The system is preferably adapted to have a hierarchy which separates meeting discussions, threads and comments. At the highest level the system allows for a meeting to be conducted which comprises at least one discussion. Each discussion may be associated to one or more context items that provide the direction for the discussion. A context item may be related to at least one of; a particular solution proposals, goals, evidence, relationship between context items, or other categories of context. Each discussion may have at least one thread associated with a branch of the discussion which may relate to a subset of context items within the discussion. Each further branch generated by the users of the system generates a further thread within the discussion. Each thread may relate to a different approach as to how to address the discussion, or may be related to different issues associated with the discussion, such as a different context item. For example, if the discussion is how to generate more funds for a council, one thread may relate to utilising council assets to generate funding, and a different thread may be directed towards selling council assets to generate funds. While the threads of the same discussion are related to council assets, the system is preferably adapted to automatically generate a separate thread for a comment which introduces a contrary concept. Simply put, if one thread context item is achieved, another thread context item may be invalidated. This is to say that a comment in a thread proposing to sell an asset will cause a comment proposing utilisation of the asset to generate funds to be contrary, and therefore the proposed solutions for each thread cannot be simultaneously achieved.

In a further example, the threads of the discussion are free-form in that a user may assign a branch attribute to a comment if the user thinks that a comment is a sub-thread of a parent thread which is also required to be discussed before the parent thread can be resolved. Discussions and context items may assist with critical thinking of users and may assist with keeping a meeting on track. Preferably, a reconciliation regarding conflicting context items or threads occurs when a thread is collapsed into a consensus comment or a summary comment.

Optionally, the context visualiser is adapted to display to a user of the system if one proposal in a thread is achieved the consequences for progressing the proposal to consensus. The context visualiser may be adapted to show a predetermined effect, such as an animation, colour change or the like to another thread, which may indicate to a user that progressing the proposal to consensus would impact at least one of a further thread, discussion or validity of a context item, such as a goal or proposal.

Preferably, the hierarchy of the system 10 has a meeting at the highest level, which comprises at least one discussion, in which each discussion comprises at least one thread, and each thread comprising at least one comment.

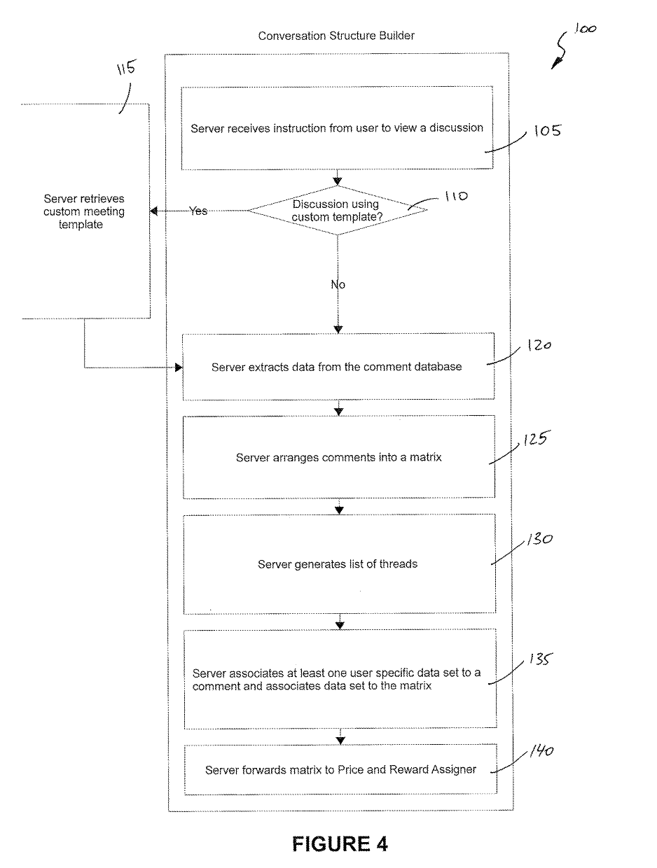

An embodiment of a flowchart for a conversation structure builder module 100, or builder module 100, is shown in FIG. 4. The builder 100 is adapted to generate the structure of a conversation for a meeting. In this embodiment, the server receives instruction from a client or member of a meeting to view a discussion 105, or the server detects that the conversation data, for example the metadata associated therewith, has changed. The output generated by the system may be required to be updated at a later time during a conversation or meeting.

The system will then perform a check 110 to determine whether or not a custom conversation template is being used. This check 110 may be an automatic check or may prompt the client for an input for a determination. If a custom conversation template is used, the server may be adapted to retrieve a nominated conversation template 115 and create a discussion, a thread, and/or placeholder comments assigned to a user. For example, if the conversation template specifies that the first discussion should be to prompt each meeting participant about their ideal solution proposal, a discussion may be created with a single thread and one placeholder comment assigned to each participant. The placeholder comment may be generated with at least one of descriptive text, audio, and/or video that asks them to respond to this question. The conversation may have a number of rules associated with in the template, which may determine the threads and conversations which currently exist in the conversation. For example, if the conversation template specifies that the second discussion should be to agree on an ideal proposal but should only begin once the first is complete, the system is preferably adapted to create the second discussion for this purpose only after all placeholder comments for the first are responded to. If a custom conversation template is not used, or the threads and discussions have been determined, the server extracts data from the comment database 120, preferably for all comments that are not ‘hidden’ in that conversation. The server then arranges comments (with metadata present) into a matrix 125 which preferably comprises at least one row and at least one column. The matrix comprises at least one column per comment in which the comment can be arranged by time, such as oldest to newest or any other predetermined time configuration. The at least one row of the matrix may assign a comment to a relevant thread. It will be appreciated that comment time and threads may be swapped, such that threads are assigned to columns and the rows may be related to the time. Other comment data may be assigned to columns and/or rows for different templates, or custom conversation templates which allows for arrangement or organisation of a meeting or conversation.

The system may be adapted to search and find duplication of closure comments with overlapping context items for a discussion. Preferably, the server can generate at least one thread or a list of threads 130 and performs the search with the comment database 55 to find at least one context item which is not hidden. This check may be performed by the server for each thread such that the server can determine whether there are any confirmed closure comments. A closure comment may be generated due to an existing or overlapping thread which may closely relate to the thread of the comment. If at least one closure comment is found the system may duplicate the closure comment or comments into the rows/columns of the first comment in overlapping or closely related threads. This may be advantageous as this allows new threads covering a context item to include the closing comment of pervious relevant threads discussed in the meeting or a previous meeting associated with the meeting being reviewed or commented on.

The server may associate user-specific data 135 for the user onto the comments. The user specific data may be stored in the comment database 55; however, any database associated with the system may store the user specific data. Associating user-specific data for a user may allow a user to identify comments which have yet to be read, listened to, or watched. The user may also assign a bookmark to a comment such that they can easily retrieve or find a comment which is deemed to be of importance by a user.

The server may associate data related to a user's remaining talk time and any context items which are not ‘hidden’ relative to the matrix. A remaining talk time may be calculated as the user's total clip lengths combined with the taxes for their comments and context items, subtracted from the combination of a user's initial talk time for a conversation and the total rewards for a user ((user's initial talk time for conversation +total rewards for user)−(their total clip lengths+total taxes of their comments and context items)). The matrix may be subsequently sent 140 to the price and reward assigner 200.

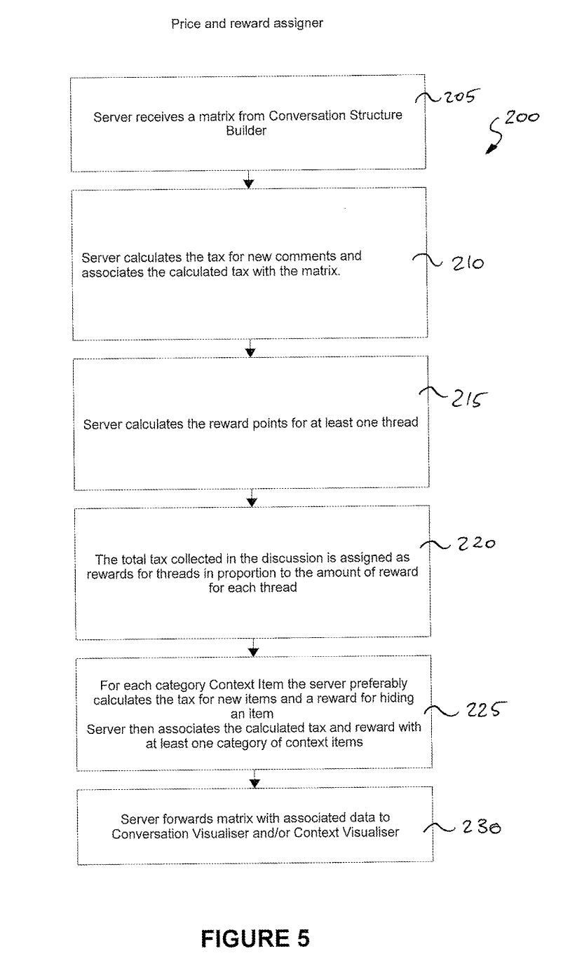

An embodiment of a price and reward assigner module 200 process is shown in FIG. 5. The price and rewards assigner 200, also referred to as assigner 200, is adapted to receive a matrix 205 from the conversation structure builder module 100 which comprises at least one data set with metadata for a conversation. It will be appreciated that not all metadata sets may be received by the price and rewards assigner, such metadata which is hidden.

Having an assigner 200 allows for implementation of a taxation and pricing scheme which preferably allows the users of the system to focus on a discussion as the amount of currency for the meeting can rapidly become depleted if the discussion extends for a predetermined length. If members of a meeting run out of currency, the system may allow a fixed number of free actions to be made, reduce fees for generating a comment and/or allow users of the system to propose summaries of the open threads to obtain rewards.

Optionally, each thread can be associated with a reward, or more preferably an entire discussion can be associated with at least one reward. The at least one of the rewards can be distributed to members of the meeting, such as the user who proposed to summarise a thread or discussion, a user who commented in a thread or discussion proposed to be closed, a user answering a question. The system may have any predetermined or custom rewards structure, which may be related to a discussion template.

If a comment is associated with a question, a reward for answering the question may also be assigned to the comment. The reward assigned to the comment may be optional, and may be dictated by at least one of the system and the user who generated the comment.

The price and reward assigner module 200 can calculate the “tax” for a new comment 210. The tax may be for example; a percentage of the comment length, a percentage of time length, based on comment frequency of a user, based on relevance of a comment or any other suitable taxation system. For example, the tax calculated for a new comment may be calculated as NewCommentTax=â(bn)+cn+d where “n” is number of comments, “a”, “b” and “c” are constants designed to make new comments prohibitively costly after a certain number and “d” is the initial tax. The certain number of comments may be the maximum number of comments target. In this example, the length of time for an audio comment or video comment may be part of either of constants “a” or “b”, which allows taxes to be increased based on longer comments. The calculated tax is then associated with the matrix and may also be stored, at least temporarily, by the system. It will be appreciated that the above equation is merely for exemplary purposes only and the system may employ other equations, algorithms or the like to calculate a taxation on a comment, thread and/or discussion.

The server may then calculate the rewards 215 for threads or discussions using a function which is relative to the number of comments in the thread, or threads, and based on the number of comments which have exceeded a consensus factor for the thread. In at least one embodiment, the thread rewards are increased based on the number of comments and increased based on the degree to which the comments are equally split between agreement and disagreement with the subject of the thread. It will be appreciated that in a further embodiment, the individual threads may not include a reward and only a discussion may include a reward. In one example, the system utilised the following formula to generate a reward: Thread Reward Points=Number of comments in thread+−(1/c)x̂2+c, in which c=Number of users who made an Agree comment+Number of users who made a Disagree comment, and x=Number of users who made an Agree comment−Number of users who made a Disagree comment. It will be appreciated that this formula is merely exemplary and the system is not limited to such a calculation. A thread reward may also be referred to herein as thread reward points.

The total tax collected 220 in the discussion is then distributed across all threads in proportion to their number of thread reward points and associated with the matrix with each thread. The tax may be an accumulation of increments of talk time, a number of new comments able to be made, or the like. Increments of talk time may be fractions of a second, seconds, minutes, hours or any other predetermined period of time.

Preferably, the total tax collected in a discussion is assigned as rewards for completing or closing threads. Threads may be assigned differing rewards based on the length of the thread, the number of comments, the number of questions asked in a thread, the number of context associated with a thread or any other predetermined rewards scheme. Taxes for a thread may at least partially be assigned to a thread as a reward, such that each new tax for a discussion can be used by the system to increase a reward for completing a thread and/or discussion.

Preferably, for at least one category of context item, the server calculates the tax for new context items 225. To calculate the new tax for a category of context item, a function may be used which factors in at least one of; an initial tax for a context item, a desired number of viewable context items (such as items not hidden), constants and other predetermined variables. For example, the function may be: New item tax=(â(bn)+cn+d)*(Max Comment Length/100), where “n” is number of not ‘hidden’ context items, “a”, “b” and “c” are constants designed to make new context items relatively more costly after a predetermined number, and “d” is the initial tax. The inclusion of ‘Max Comment Length’ in this algorithm may be used to convert the tax for new context items into the same currency as the tax for new comments, which is seconds of talk time in these examples. Preferably, the new context items are relatively more costly after a predetermined threshold of number of context items =is reached. Rewards may also be generated by hiding a context item; rewards may also be generated relative to at least a portion of the tax. The server may then calculate a tax and a reward for each category of context item and associate data for the tax and/or rewards, or a portion thereof, to a relevant matrix. The server then forwards the matrix 230 with associated data to the user device 30 for display by the conversation visualiser 300 and context visualiser 1000.

The tax for a new context item is used such that the number of proposals or new items can be kept to a manageable level, and therefore the meeting can be concluded without undue hindrance of too many new items. This may keep the number of proposals generated to a manageable level and provide a constructive and/or concise meeting.

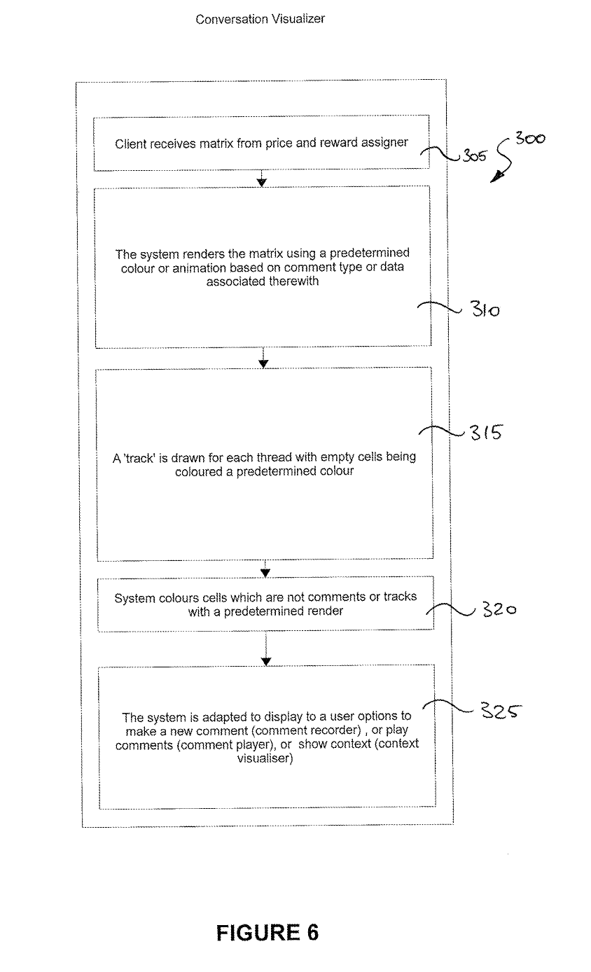

FIG. 6 illustrates an embodiment the conversation visualiser 300, also referred to as the discussion visualiser 300. The conversation visualiser 300 is adapted to receive the matrix 305 and generate a visual representation of at least a portion of a conversation threads and/or meeting based on the matrix received. The matrix is preferably associated with the tax and rewards for a comment or thread, such that the system can generate a reward for closing or summarising a thread and adjust taxes for a conversation to either deter comments or encourage comments. For example, if a thread has remained open for a period of time without a resolution, the system may lower taxes to make a comment and/or raise rewards for closing the thread or discussion. The client or application associated with the user device 30 is adapted to render the matrix as a visual representation 310, such as a chart, a table, a graph or any other visual representation. For example, the table may have an axis of time vs. thread, however it will be appreciated that the time axis may not be to scale such that all comment visualisations are relatively similar or the same in dimensional appearance.

The rendered matrix may have a number of predetermined markers, such as symbols and/or colours, assigned to the visual representation. This allows a user to more easily identify comments which have a predetermined meaning, such as a question or an answer to a question, without viewing or listening to the comment. For example, a red colour coded comment may indicate disagreement with the proposition made in the thread and the intensity of the colour may indicate the number of likes of the comment relative to the number of people in the meeting and hence collectively more disagreement.

Preferably, the matrix is rendered, or displayed, as a table using colours and styles to visualize key data for each comment in a respective table cell. In one example, a general comment may have the following cell colours assigned; Question=Cyan, Answer=Blue, Agree=Green, Disagree=Red, Comment=Grey, Summary=Yellow, Closure=Magenta. A like or upvote may grade the opacity of a cell in the table, for example graded between no likes=50% opacity, everyone likes=100% opacity, and dislikes may reduce the opacity of the cell. A placeholder may comprise a cell colour which is white with a boarder, such as a grey boarder, a bookmark may be an icon assigned to a cell. Cells which have not been at least one of; viewed, listened to or watched may have an animation applied to the cell, for example a pulse or other animation to signify content to a user which has not yet been consumed. A currently viewed comment or a comment playing may have a black boarder for example. In yet a further embodiment, the system is adapted to allow customisation of cells by a user setting up a meeting or a member of a meeting, or cells may be generated via a conversation template, which may be a custom conversation template.

Data may also be assigned by a user profile, which may relate to a bookmarked comment cell, a comment tagged as ‘viewed’ or ‘not yet viewed’, a liked comment, a disliked comment, or a custom marker. Other positions of a cell, such as the end of a thread, may have a marker assigned to notify members of a meeting that the there is a comment to be replied to, or a pending unanswered question, a suggestion for review or any other desirable cell type which requires at least one member of a meeting to respond to. A placeholder may be assigned to a current user with no response recorded for a particular cell or if a member of a meeting is requested to respond to a particular cell. It will be appreciated that the cell colours assigned, opacity and icons are for exemplary purposes only and variations or combinations of each may be used by the system.

Each thread generated by the conversation visualiser 300 comprises a link to at least one comment cell which originates from the initial discussion comment cell. A comment cell in a thread may be a ‘branch’ origin for a further thread or may be part of a ‘track’ that comprises subsequent comments in the thread 315. A track cell follows a cell in the same row in the table, and a branch cell is one which forms a new row in the table. This preferably allows threads of a discussion to be split such that each thread can be addressed individually, or discontinued if it is not relevant to the meeting or is resolved by consensus of the participants.

It yet another embodiment, the visual representation of a cell may be representative of the size or length of a comment. This is to say that a comment 30 seconds in length may be visually around half as wide on the screen as a comment 60 seconds in length. Other sizing may also be used, such as a scale sizing of comments. Discussion threads displayed by the system may be expended and contracted at a user's discretion, such that threads that the user is not interested in may be minimised. It will be appreciated that the system may not allow threads or discussions to be minimised.

The system is preferably adapted to render or otherwise assign a visual marker, such as a colour, to a conversation visualiser based on whether or not there are any branches in the thread 320. If there are no branches in the thread or the discussion is shown in a vertically collapsed view, each of the comments will preferably be shown in a consecutive order without “gaps” between comments in the X axis, in the example of a graph. In an expanded view, the comments will be separated into threads in the Y axis and the comments retain their position in the X axis relative to the collapsed view. However, as the comments retain their relative positions in the X axis a link is formed between comments in the same thread to visually represent that comments are part of the same thread. A further variation of the collapsed view is that the user may select to show only comments from one thread and hide all others, such that the X axis has no gaps and each consecutive comment on the X axis is part of the same thread. This variation may be advantageous, as it may be adapted to consume the comments on one thread in linear fashion then move on to the next thread.

Referring to FIG. 15, there is illustrated an expanded view of a discussion in which there are a plurality of threads. The comments for each of the threads are illustrated in a comment order which corresponds to the time in which the comment was generated. The white “tracks” of the threads are links between comments for a thread, and typically do not contain any comments, although may contain metadata related to at least one comment, and are intended to easily lead a user of the system through the conversation in a logical order. It will be appreciated that other predetermined graphical representations of a discussion and associated threads may be generated by the system.

A user of the system can generate an input via a user device and upload the input to the system. The input is preferably a comment related to a discussion, however the input may also be a like, a dislike, a vote, a bookmark, a flag, a document, a data set, a status, a comment is read, a comment is unread, or any other predetermined input or data set. If the input form the user is a comment, the comment input will preferably be rendered based on the context of the comment. For example, the context may be; a question, an answer, a summary, an agreement, a disagreement, an attempted closure of a thread, a response to a placeholder or another type of comment. The rendered colour can correspond to a legend of the meeting; however, the legend may be optionally visible to the users of the system.

The system is adapted to display a plurality of options to an authorised user of the system or member of a meeting. The options can relate to inputs for the system, such as make a new comment, play or view comments, play unlistened comments, show context, apply a filter, apply a rule, expand a discussion, collapse a discussion or any other predetermined option. The context visualiser 1000 may be adapted to visually represent at least one context item selected or input by a user of the system 10.

If there are no branch points for the first comment in the thread, empty cells of the row prior to that comment are rendered a predetermined background colour. The system may colour cells that are not comments or tracks with a background colour. At least one option may be displayed to a user 325 to generate a new comment 50, which may be generated by the comment recorder 700. Another option displayed to a user may be to view a comment via the comment player 400, or to view the context of at least one comment via the context visualiser 1000. Viewing the context of a comment may cause a display window presented to a user to be expanded, such that at least a portion of the context items for the comment and discussion is shown relative to those of the entire meeting. The threads an comments associated with discussion may be filtered to find a comment or a thread which a user wishes to view or find a context item associated with at least one comment.

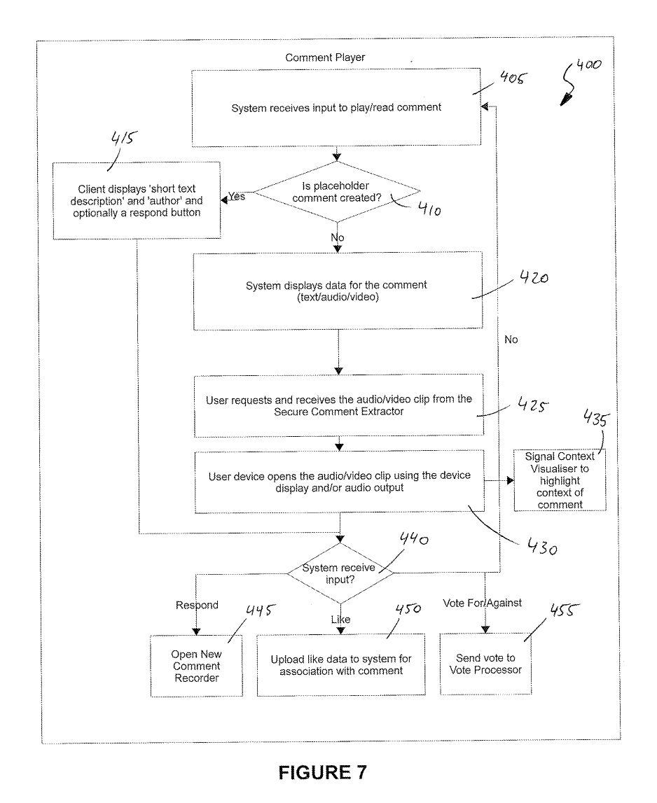

FIG. 7 depicts an embodiment of a flowchart for a process of the comment player 400. The comment player 400 may be adapted to display comments, images, or video via the display of the user device, or may be adapted to playback audio via the audio hardware of the user device.

The system is adapted to receive an input 405 to select and/or play a comment. Playing a comment may be achieved by a user manually selecting a comment cell for play, or the system playing a comment based on a progression of listening to comments. The system may be adapted to play comment in a chronological order from more than one thread, or may be adapted to play comments in any desired order from a single thread. Optionally, a filter to skip already listened to comments may be applied to the system, such that a user can save more time if they have already heard a number of comments in a thread or discussion. In yet a further embodiment, the system 10 may be adapted to allow a user to queue up multiple comments in a desired order.

In yet another embodiment, members of a meeting may send personal messages to other members of the same meeting, or a spectator of a meeting, in which at least one comment of a discussion can be associated with the message. Further, each comment associated with the message may be started at a predetermined time which can be specified by the user sending the message.

A placeholder may be generated 410 by a conversation template, such that a comment in response is encouraged to be made for a comment with a placeholder. If a placeholder is generated, the system is adapted to display a data set on the user device 415 (which may be displayed via a client or application of the system), such as text relating to an author and/or title of the comment. The placeholder preferably contains details viewable by at least one member of the meeting or a user of the system, which is requested to be addressed. For example, a placeholder may be generated for a pre-determined question defined in a discussion template such that a member of a meeting or user of the system can easily identify unanswered questions that they would ideally respond to, or any other action which requires a comment from a user. A respond option may be associated with the placeholder, such that the placeholder comment can directly be responded to and linked to the response. In at least one embodiment, the system is adapted to alert or notify a user or member of a meeting when a placeholder relevant to said user or member of a meeting is generated, or a response is for a placeholder comment is made, or a consensus is reached for a thread. A placeholder may further be directed to a member of a meeting or a user of the system, such that they are the only allowable respondents.

In the context of the present disclosure, an alert is intended to include at least one of; a message, a vibration, a sound, a notification, an email, an inbox message, or any other predetermined alert which attempts to notify a user of the system to a new development for a meeting. This may further accelerate the time in which a proposed solution is agreed upon or whether a proposed resolution reaches a consensus.

If no placeholder comment is selected 420, the system is adapted to display at least one data set associated with a regular comment. The at least one data set can comprise data relating to metadata of the matrix. For example, data sets may include; audio data, video data, text, an author of the comment, an image associated with a user profile, a description of the comment, a number of likes, a number of dislikes, a number of votes, a consensus percentage, or the like. An option may be provided to a member of a meeting such as the option to respond, like or dislike (if user has not liked or disliked it already), vote for or against a comment (if the comment is a summary or closure type).

The user device is preferably adapted to send and receive audio data and/or video data 425 from the secure comment extractor 500. If data is received by the user device, the user device will provide the option to the user to play, view or read received data via the user device 430. It will be appreciated that the user device will have at least one of a display screen and/or an audio output. The context visualiser 1000 may also be utilised to highlight or identify the context of the comment 435.

In either case, whether or not a placeholder comment is selected, the system determines whether the user has generated an input 440, such as whether an option displayed to the user has been interacted with. If no interaction has been detected the system will return to step 405 and await input. If an input has been received the system is adapted to determine the input type. The input type may be a response 445, a like 450, a vote 455 or any other predetermined input. If a response is selected by the user, a new comment recorder may be opened to record a message, such as a video message, an audio message, or a text message. A like may indicate that there is an agreeance for at least a portion of the comment. A like counter may be displayed to users of the system and optionally a different colour or effect may be rendered to the comment for display to at least one user. Further, a vote for or against a comment may be displayed to at least one user of the system which can generate a consensus for a comment based on a determination from the vote processor.

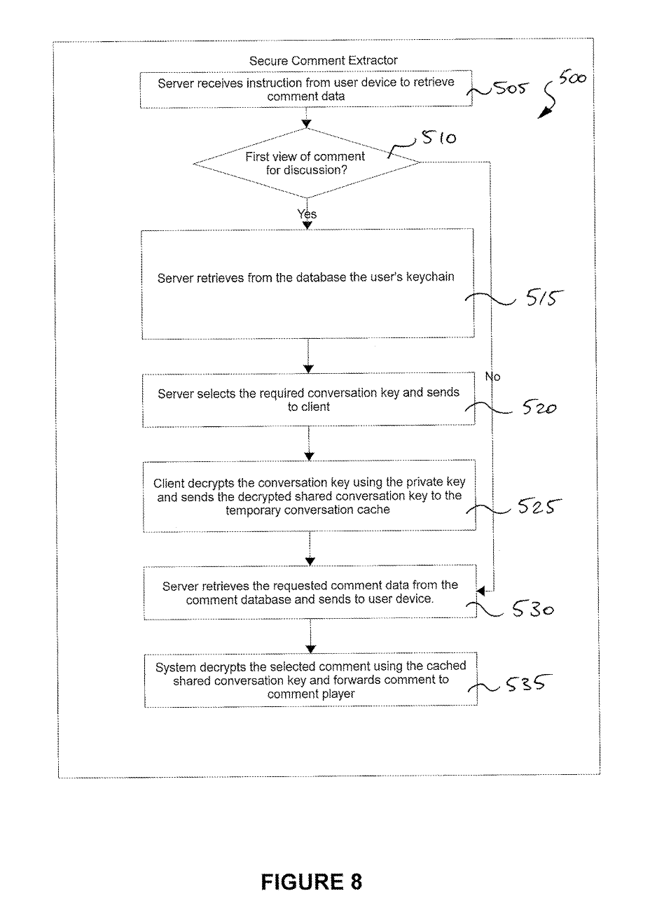

Turning to FIG. 8, there is shown a process for an embodiment of the secure comment extractor 500. The system can receive a request or set of instructions from the user to retrieve or view at least one comment and at least a portion of the data associated therewith 505. The system determines whether or not this is the first time the user has viewed/listened to the comment 510. If the comment has yet to be viewed or listened to the system retrieves from the database the user keychain, which may comprise one or more shared conversation keys. The shared conversation keys associated with the keychain are preferably encrypted or have at least one security protocol associated therewith such that keys are kept reasonably secure and accessible only to that user 515.

Preferably, when a conversation is generated the server is adapted to generate a shared conversation key. The shared conversation key may then be sent to a user requesting access to a comment if they have sufficient authorisation to access the shared conversation key. If a user has authorisation to access the conversation key, the conversation key may be encrypted with a respective user public key in the user keychain. The encrypted key is then stored in the user's keychain which is associated to the meeting in which a comment is requested to be viewed. The unencrypted shared conversation key is then deleted or otherwise destroyed such that others cannot access the unencrypted shared conversation key without authorisation. Authorisation to access the unencrypted shared conversation key may be given by a member of a meeting, referred to as a sponsor, or a user with a sufficient level of authority, such as a system or meeting administrator. Eencrypting and depositing the shared conversation key in user keychains then subsequently deleting the unencrypted key allows improved secrecy of comment data for meeting participants and distribution of the shared conversation key regardless of whether all users and their devices are accessible at the time of meeting creation.

If the user profile may have sufficient access to associate with the user device and the meeting, the system selects the requested shared conversation key from the user's keychain and sends the key to the user device 520, such that the user device contains an encrypted conversation key to match the meeting. If no such encrypted key is associated with the user profile initiating the request the system will not allow access to the comments of the meeting. The shared conversation key is decrypted using the user's private key 70 stored in the user's device. The decrypted shared conversation key is then temporarily stored in a conversation key cache 75 associated with the user profile on their device. In another embodiment, the user private key 70 may be stored on the server in the user's keychain, removing responsibility from the user to protect their private key and instead relying on the server's access check to protect it. In a further embodiment, the temporarily decrypted shared conversation key is stored on the server associated with the user profile and is used to decrypt comment data prior to sending it to the user's device.

If the conversation key is decrypted, the system allows access for the user profile to access at least one comment 530. The at least one comment may be saved or temporarily stored by the user device. The comment is subsequently decrypted using the shared conversation key and the comment is forwarded to the comment player 400.

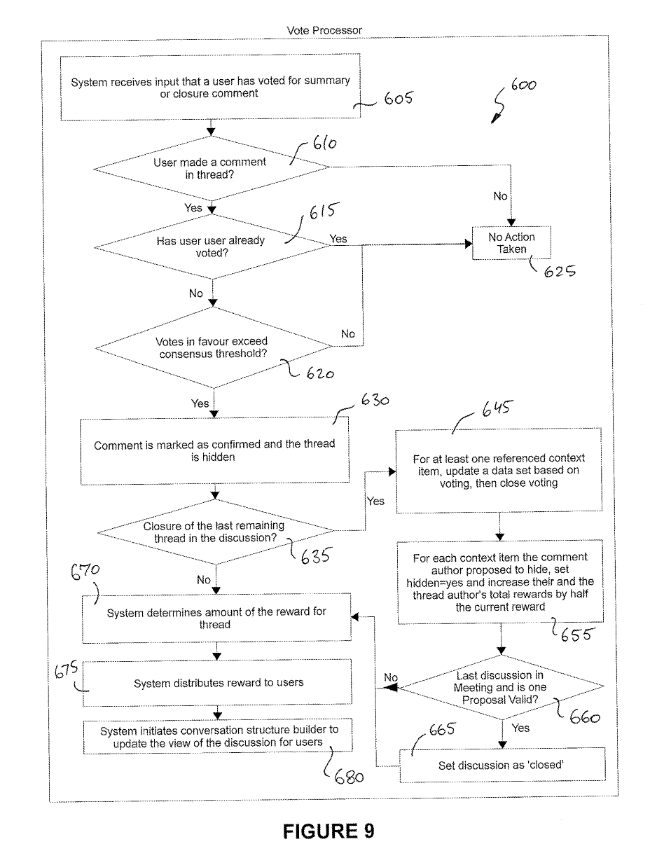

Referring to FIG. 9, there is shown an embodiment of a process for a vote processor 600. The vote processor is adapted to determine whether a consensus is reached based on members of a meeting voting for a comment. Typically, a vote will be for a summary or closure comment for a discussion thread; however the system may allow voting for other types of comments also. Voting for a closure comment may close at least one thread for a discussion, which is desirable when the closure comment expresses a position that resolves the issues or questions that are the subject of the thread. Voting for a summary comment is desirable when the summary comment captures all the important and relevant points made in comments of the thread covered by that summary comment. It may be desirable to have a consensus level of meeting participants vote for a closure or summary comment because that will cause the comments that are the subject of the summary or closure comment (but not the summary or closure comment itself) to be hidden and hence make the overall conservation a shorter length and progress it toward a final resolution.

When a user casts a vote 605, the system can perform a check to determine whether or not the person casting the vote has made any prior comments in the thread 610 or the discussion. If the user has previously made a comment in the thread or discussion, the vote from the user can be counted to generate a consensus for a summary or closure comment. The system will determine whether the user has already cast a vote 615, such that the user cannot cast multiple votes. The system may be adapted to compare the number of votes in favour of a comment with a predetermined voting threshold 620. For example, if there are ten (10) eligible members of a meeting who are able to cast a vote with a voting threshold of at least 70%, at least seven (7) of the ten (10) eligible members will need to vote in favour. It will be appreciated that a time limit may be imposed on a meeting for voting, such that if no vote is received from an eligible member of the meeting in a predetermined period of time, the eligible member will be removed from the list of eligible members of the meeting. This is to say that if there are ten (10) members of a meeting who are eligible to vote and two (2) members of the meeting have not voted before the time limit, the total number of eligible members will be eight (8) to determine the consensus percentage. Any predetermined voting threshold may be used by the system, and optionally the system may allow members of a meeting to change their vote while voting options are open.

Preferably, if the user has not made a comment 610, has already voted 615, or if the predetermined threshold is not met, the system takes no action 625 or the votes are considered to be ignored or void. However, if the predetermined voting threshold is exceeded, the system assigns a “confirmed” attribute to the comment 630. Optionally, when a confirmed attribute is assigned to a thread, the prior comments in that thread are also marked with a “hidden” attribute.

Once a thread is closed or summarised, the system checks if all threads for a discussion are closed 635. If all threads are closed, the system may be adapted to assign a “hidden” attribute to at least one, but more preferably all, comments made in the thread subsequent to the successful closure comment. Further, the voting for context items referenced in comments of the discussion may be closed and their ‘valid’ attribute updated to match the selections of the user who made the successful closure comment 645. The possible context item ‘valid’ attribute values could be one of ‘Yes’, ‘No’, ‘Undecided’ or other predetermined values. Further, if the author of the successful closure comment had selected that a context item be hidden, the ‘hidden’ attribute value of the context item will be marked ‘Yes’ and the reward for hiding a context item of that category may be distributed between the author of the context item and the author of the successful closure comment 655. The distribution of the reward for hiding a context item may be varied in the conversation template or another predetermined calculation within the system such that the incentive to hide proposals or other context items is effective. An incentive may include a virtual currency, a fiat currency or any other predetermined incentive.

If the vote caused the discussion to be closed, the system then checks if the discussion being closed was the last open discussion in the conversation and if there is only one valid proposal 660. In this case, the conversation may be closed and archived and the successful proposal and consensus closure comments will be the outcome of the conversation 655. Once a conversation is closed, interactions with the discussion may be restricted or prohibited. Optionally, at least one thread may be manually reactivated by a member of the meeting with sufficient authorisation.

A valid proposal may include a proposed solution, a proposed resolution, or any other pending suggestion for a discussion which may resolve at least one issue associated with a meeting.

If an author is listed in the thread, the author may be entitled to further rewards when a thread is closed. If the author is listed in the thread comments, this is to say that the author is not hidden or anonymous, the system may increase or assign a reward to the author with the closure of the thread. If no author is listed for a comment in a closing thread, the author for the comment in the closing thread at least one of; does not receive a reward, or does not does not have their reward increased. The system may then check 660 whether the closing thread is the last closing thread for the discussion, and if so the discussion may be ended or achieved. If there are other pending valid proposals, these are preferably required to be resolved before the system can accept a valid proposal. A valid proposal may include a proposed solution, a proposed resolution, or any other pending suggestion for a discussion which may resolve at least one issue associated with a meeting.

Once a conversation is closed, interactions with the discussion may be restricted or prohibited 665. Optionally, at least one thread may be manually reopened by a member of the meeting with sufficient authorisation. If the thread is reopened, the rewards associated the reopened thread will generally be less than the rewards at the time of closing the thread, however any reward and taxation system may be used by the system or assigned by a discussion template. When each thread closes, regardless of whether there are other threads open, the system can generate or calculate the reward for the thread 670. The reward may be additional comment time, minutes, or any other suitable reward, such as advancing to the next round of discussion. For example, a summary may provide the summariser with 50% of the reward for the thread, while a closure of a thread may provide 100% of the remaining rewards to the user who closes the thread. It will be appreciated that other factors may impact the disbursement of rewards to users.

Optionally, a percentage of the rewards may be also distributed to users for constructive involvement with the thread of a discussion. For example, if a summary is formed, with 50% of the rewards going to the summariser, the remaining 50% of the rewards can be shared between those who made the comments 675.

Once a discussion is closed, or a thread is closed, the conversation builder may update the view supplied to a user 680, such that threads which have closed may appear in a different colour, or may be collapsed into the conversation. For example, the closure comment that achieved consensus for a thread may appear as a comment in the thread from which the closed thread branched and the closed thread itself may be hidden in entirety. Further, closing at least one discussion or thread with at least one context item may impact on other discussions, particularly if closing a discussion would invalidate a second discussion associated with at least one further context item which is contrary to the closing discussion context item. For example, if one discussion associated with an evidence context item concluded with consensus that the evidence was invalid, the context visualiser would highlight that a proposal context item with a relationship to that evidence was also invalid, regardless of the outcome of a previous discussion about the proposal in isolation.

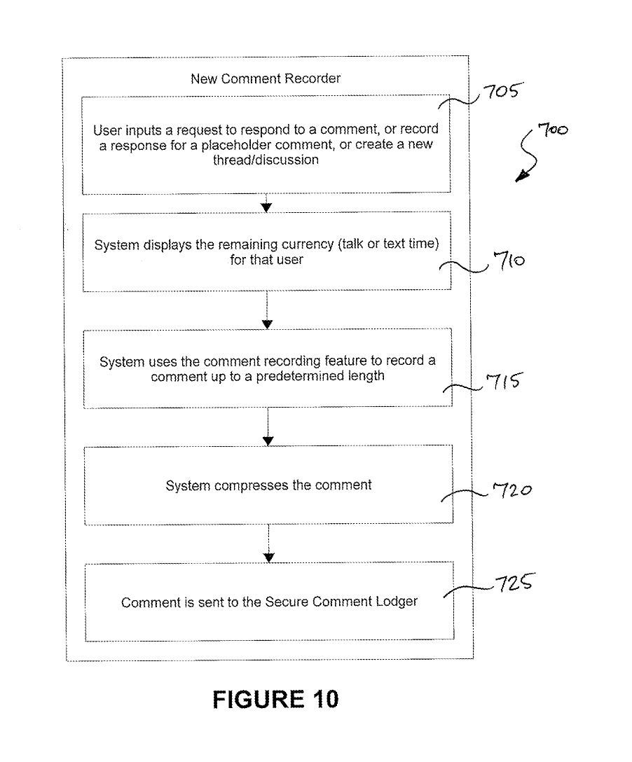

FIG. 10 depicts an embodiment of a new comment recorder 700 adapted for use with the system 10. The system preferably allows a user to generate a new comment, which is typically in response to a comment 705, if the member of the meeting wishes to make a contribution to a thread of a discussion or start a new thread. The new comment recorder may provide details to a user relating to the proposed comment, such as where the comment will fall in the thread or a comment to be replied to. Other details, such as the remaining talking time of the user may be displayed, along with the tax for the proposed comment 710. The recording feature may allow for at least one of; text, audio, and video data to be captured for the comment, which may be capped to a character limit for text, or a length of audio/video recording time 715. Optionally, the system then compresses the comment 720 for upload to the system such that the quality is reduced, but still may convey a comment with sufficient clarity. The user device then uploads or sends the comment to the system, preferably to the secure comment lodger 800 to be posted in the discussion 725.

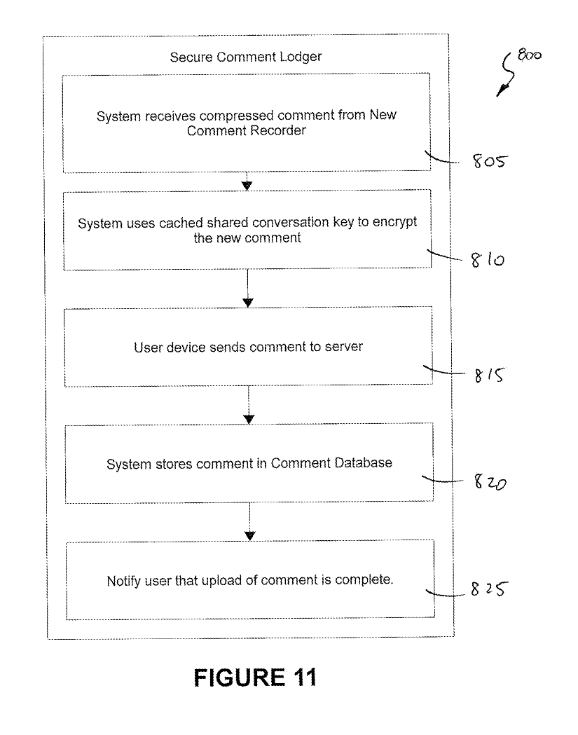

An embodiment of the secure comment lodger 800 is shown in FIG. 11, and allows the system to receive at least one comment from a user which is encrypted or otherwise has a security feature applied thereto. The lodger 800 receives a comment generated by a user 805 from the new comment recorder 700. The cached shared conversation key is used to encrypt the comment 810 before being sent to the server of the system 815. The server then stores the comment data 820 in the comment database 55 and a message is provided via the new comment recorder 825 of the success of the upload. It will be appreciated that the system may have an offline mode in which a discussion, or part thereof, can be saved to a user device and comments generated for the discussion which are uploaded when the user connects to the server of the system at a later time.

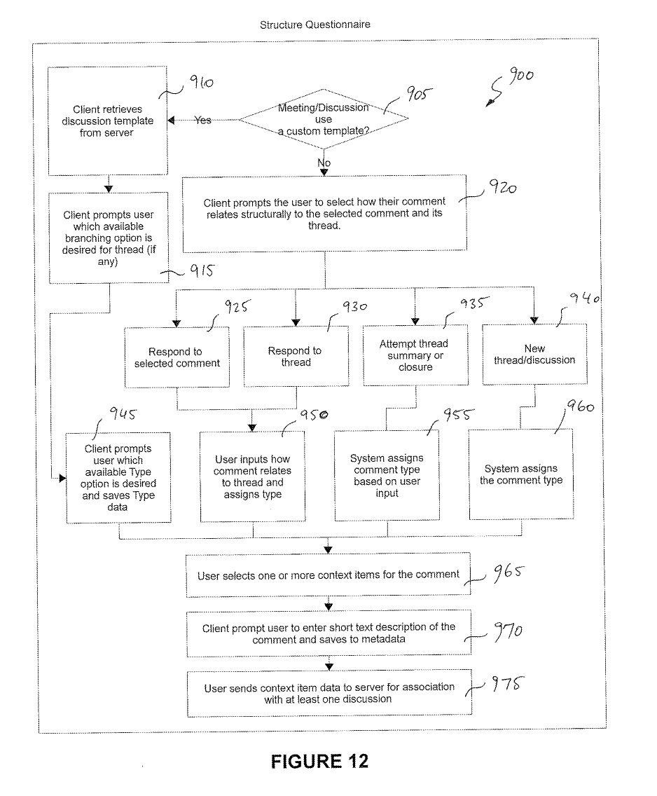

FIG. 12 illustrates an embodiment of a structure questionnaire 900 suitable for use with the system 10. The structure questionnaire 900 is adapted to determine whether the meeting is configured to follow a custom template, such as a discussion template, and may assign metadata to at least one comment to be stored in at least one database, such as a comment database 55, of the system 10. If a custom template 40 is used for a discussion, the system 10 retrieves the nominated discussion template 40 from the server 20 and extracts the allowable comment types and branching options for the currently selected comment in the thread.

The system may issue a prompt or alert to the user of the system to select which branching option is desired, if there are a plurality of options, and saves the branch point and thread metadata as defined by the option. Throughout this specification, metadata may be “data”, or a “data set”, and vice versa. It will be appreciated that the system may be associated with at least one rule such that the option may be automatically selected without input from a user. A further prompt to a user may request a user to define the type of comment and the type of comment selected by a user will be associated with the comment 945.

If no discussion template was used, the system may prompt the user to select how their comment relates to at least one of a discussion, a thread, or a comment 920. If the newly generated comment is in response to a comment 925, a branch point is formed by the system. Other comments may be a response to a thread 930, a summary or closure attempt 935 or a new thread 940. Responding to a comment 925 or a response to a thread 930 may also prompt the user to specify the comment type 950 and how the comment relates to the thread or the comment, for example; is the comment a question, an answer, an agreeance, a disagreement and saves the selected type to the comment data. If the comment is a proposed new thread or relates to a summary or closure of a thread, the system may automatically assign type data to a comment 955, 960.

After a type has been associated with the comment, 945, 950, 955, 960, the user is prompted to select one or more context items that correspond to their comments 965. The system preferably restricts the user from selecting context items assigned to another currently open discussion as it is desirable that a context item only be the subject of one open discussion at a time. A user may manually enter a small text description for the comment 970, or the system may convert speech to text to automatically generate a text description for a comment. The type and context data may then be uploaded to the system with the new comment 975.

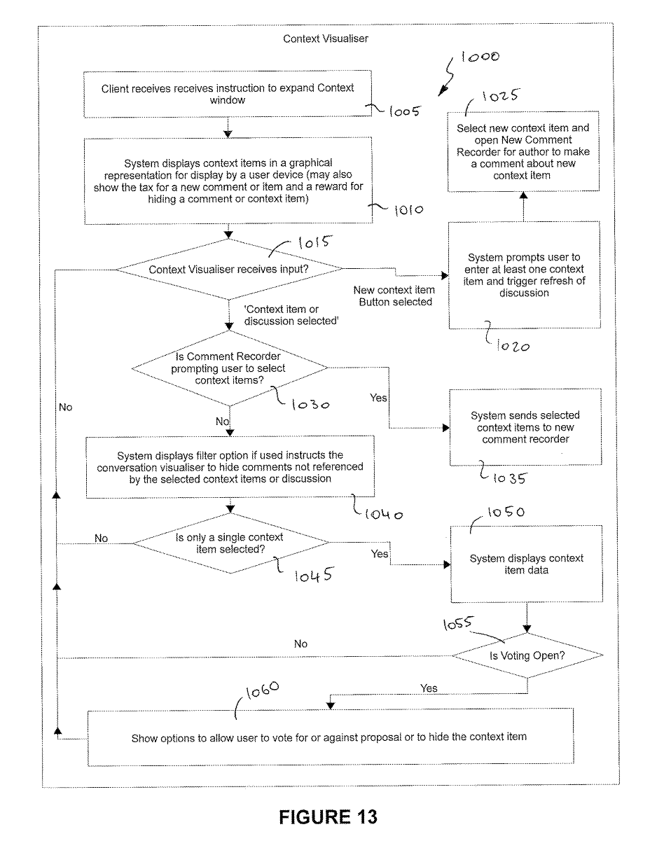

FIG. 13 illustrates an embodiment of a context visualiser 1000, which allows view of the conversation's goals, proposals, evidence or other custom context items and the relationships between them and their association with discussions, threads and comments. If the system receives an input to expand the context window 1005 the system may display to a user zero or more context items grouped in categories, such as goals, proposals, evidence or a custom category, and relationships between them 1010 with additional relevant information integrated within, surrounding or accessible from those items and relationships.

A context item may be associated in one discussion only, and the context item may not be associated with another discussion. There may be circumstances in which a discussion may require a single context item to be shared for a discussion to make logical sense, and therefore a single context item can be requested to be used for more than one discussion at a time. The request for using a context item in more than one discussion simultaneously may be allowed or denied by a meeting organiser. This may ensure that discussions are kept to fewer context items such that discussions are not excessive in length and can be easily resolved.

It will be appreciated that other discussions may also have comments regarding context items already in use by another discussion without associating the context item to the comment. In this way, a discussion which cannot be associated with, or is not associated with, a context item can still progress and make logical sense; however the outcome of the thread will not impact the validity of the context item unless the comment is associated therewith.

In yet another embodiment, the system allows for at least two discussions (discussion A and discussion B) to be merged such that a context item can be discussed in a single conversation. Further, if the context item is resolved or discontinued from the discussion, each original discussion (discussion A and discussion B) may again be separated.

A relationship of context items may be graphically represented to a user such that they may more easily see the how discussion of a meeting are impacting the context items, and how one comment, thread or discussion may relate to another comment, thread or discussion. Due to the hierarchy of the meeting, it is unlikely that a comment from a first discussion, discussion A, will impact a decision from a second discussion, discussion B. Some examples of context item relationships can be seen in Table 1.

Preferably, a context item is a proposed outcome related to a meeting or evidence related to a meeting. The proposed outcomes may be proposed solutions, agenda items to discuss, or context items of a meeting. More preferred outcomes may be generated during the progress of the meeting which may be resultant of a discussion held within a meeting, or the meeting may have the goal of generating more proposed outcomes.

Referring to Table 1, context items may have category data assigned thereto such that they can be arranged in a table or matrix for visualisation. For example, ‘goals’ may be assigned “1” category, ‘proposals’ may be assigned a “2” category (or other numerical categories) and ‘evidence’ for the goals and proposals may be assigned alphanumerical values. It will be appreciated that any number of context items may be visualised for a conversation, however it is preferred that there is an upper limit to the maximum amount of context items in a discussion such that meetings may have multiple discussions simultaneously.

TABLE 1

| | | |
|---|---|---|
| 1 | Relationship 1A | Relationship 1B |
| 2 | Relationship 2A | Relationship 2B |
| 3 | Relationship 3A | Relationship 3B |
| | A | B |

A cell of the Table 1, for example, 1A, corresponds to the context item ‘1’ and context item in ‘A’; however it will be appreciated that a single context item may independently be selected. For example, a user may wish to generate a comment on a context item in the Y axis alone without reference to a context item on the X axis, or vice versa. Further, a user may also select as many context items for a single comment as desired. For example, a user can optionally select context items 1, A and B for reference in a single comment. Depending on the number of context items selected and the context of the comment made by the user, a new thread may be generated when more context items are added to a discussion, or the user assigns the context items to a thread with an opposing view. It will be appreciated that the number of categories in the table may be flexible based on user inputs and/or templates (such as a conversation template) used for the meeting. A maximum number of categories may be predetermined such that existing categories must be hidden or removed prior to new categories being generated. It will be appreciated that the matrices of relationships can join or associate context items of different categories, resulting in several matrices if there are several categories.

In yet another embodiment, a context item may be assigned with options that a user may apply when referring to a context item. For example, a context item may have a ‘for’ or ‘against’ option, such that when a new comment is made associated with a context item, the user generating the comment can choose an option such that it is more clear for other users and/or the system the context of the comment.

A discussion preferably comprises at least one comment associated with at least one context item. The at least one context item may be a goal or proposal associated with the meeting which is up for discussion. Associating a comment with a context item assists with keeping the comment, thread, discussion and meeting targeted to predetermined agenda topics, goals, proposals, evidence or the like and may assist with critical thinking and keeping a meeting productive. It will be appreciated that a discussion, meeting, and/or comment need not be associated with a context item.

Voting to hide a context item, such as a proposal, is preferably associated with at least one comment, such as a closure comment or a summary comment. Hiding a thread or proposal may assist with keeping a discussion on track as there are fewer threads observable and to reduce the potential for users to want to generate comments for closed threads. Other types of comments may also be used to vote on the closure of a thread, such as an answer to a question or a comment on a thread which has been agreed upon which cancels the validity of an open thread. Closing a thread and/or discussion may allow context items to be unlocked or make available context items from that discussion thread for use in another discussion or thread. Optionally, a context item may also be hidden if members of the meting deem the context item to be superfluous.

Different tiers of taxation may be applied to comments and/or users. Generally, the price of a higher level action is more costly than a lower level action. The level hierarchy may be discussion, thread and comment, in which the discussion is the highest level, a thread is middle level and a comment is the lowest level. In yet another embodiment, a meeting can be established as the highest level with the next highest level being a discussion, then thread and at the lowest level a comment. As such, the relative cost for making a new discussion may generally be higher than that of making a comment. However, a template may have at least one discussion assigned with a reduced cost or free cost to allow for a meeting to start without adversely or unfairly requiring a user to pay an unreasonable price.

Preferably, once a discussion is started, users of the system may be assigned a placeholder comment in the discussion. The placeholder may allow at least one user to introduce themselves in the meeting, or link user information to the discussion and/or meeting. In this way other users may know who other members of a meeting are. It will be appreciated that the system may be adapted to display the members of a meeting without a user responding to a placeholder comment. Further, the system may be adapted to allow users to have a predetermined placeholder comment uploaded for at least one meeting. The system may also be adapted to retain a placeholder for a predetermined period of time, in which if user does not respond to the placeholder comment before the expiry of the predetermined period of time the user can be removed from the meeting.

Comments are in a thread, in which each row is a thread and each column comprises at least one comment. The comments may or may not be associated with at least one context item. However, comments made may propose to generate a new context item, which may be associated with a price. New comments for a thread cannot select a context item which has already been selected for an open discussion.

A meeting includes at least one discussion, a discussion includes at least one thread, and a thread includes at least one comment. Separating the meeting into subgroups assists with expansion and contraction of the meeting for visualisation.

In at least one embodiment, groups of context items referenced in open discussions (wherein voting on the context items is still open) may have a bold grey border around the groups of items (excluding items referenced in duplicated ‘confirmed closure’ comments). For closed threads or discussions (wherein voting is closed) there may be a grey cell background colour for any item referenced in a closed discussion/thread comments. A selected thread may have a bold black border around groups of items that are referenced in the discussion/thread comments. A context item or relationship cell may have a green tick/red cross icon for validity yes/no or blank for validity unconfirmed or an asterisk if a user is proposing to hide the context item. If an unconfirmed closure comment in the last thread of a discussion is currently playing, at least one of; a grey tick, grey cross, blank, or ‘hide’ icon is shown based on the author's vote for/against and whether they have selected to propose hiding it. The votes for or against may be shown as a pie chart icon overlay showing percentage of participants voting for, against, not voted. A currently playing comment may have a black border and an animation (border flashes on and off) around group of items referenced by the currently playing comment (signalled from comment player). It will be appreciated that the system is not limited to the above renderings and animations, and any predetermined or custom renderings, images or animations may be used with the system. Optionally, the system 10 may display inputs such as ‘new’ on each new category of context items with its ‘new item tax’ and ‘reward for hiding’ listed. It will be appreciated that some elements may be exempt from context item categories, such as the relationship between context items for example.

If the user interacts (i.e. clicks or sends an input) with the context visualiser 1015 by selecting the ‘new context item’ button, the system may prompt the user 1020 to enter at least one of; a title, description, an attachment/link for new context item. The system 10 may then save this to the comment database on the server with author and the new item tax deducted from the user's balance, and may trigger a refresh of the discussion based on the new content. Optionally, the new context item may then be selected and the comment recorder may be opened for the author to make a comment about the new context item as a new thread or discussion 1025.

If the user interacts with the context visualiser 1015 by selecting one or more context items, or interacts with a border of a thread or discussion, the system will determine if the comment recorder 700 was prompting the user to select context items from the context visualiser 1030. If the comment recorder 700 was prompting the user 1035 the system sends the list of context items selected to the comment recorder 700. If there is no prompt, a filter option may be displayed to a user 1040. If the filter option is interacted with 1045, the conversation visualiser 300 may be adapted to hide all comments which are not referenced by at least one of the context items selected. If there is only one context item selected, the context item is displayed to a user 1050 and a determination whether voting is still open for the item is made 1055. If the voting is still open, the system may be adapted to show voting options 1060, which may add or remove a user from the server's list of users who voted for or against or are undecided about the context item in the comment database. For categories other than relationship, the ‘propose hide’ option may add or remove a user from a ‘propose hide’ list on the context item in comment database if desired.

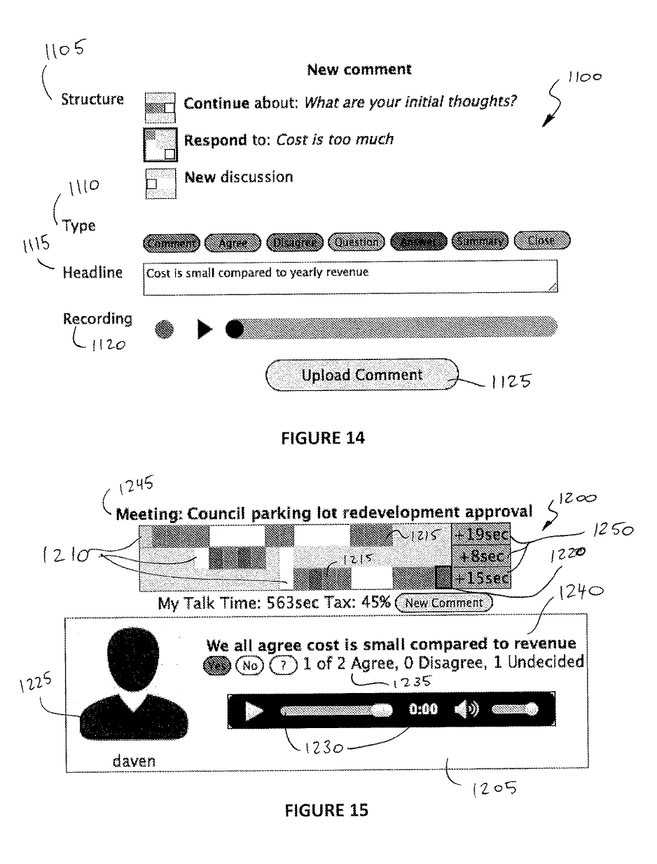

An example of a new comment 1100 window is shown in FIG. 14 which may be generated by the system. When the comment recorder 700 is opened, the structure of the comment 110 may be selected which may continue a thread, respond to a comment, attempt to close or summarise a thread, or create a new thread. The type of comment 1110, headline (or description) 1115 and an audio and/or video comment 1120 may also be input. After all mandatory data inputs have been completed, the user may then upload the comment to the system 10 via an input button or the like 1125.

Turning now to FIG. 15, there is shown an embodiment of a discussion 1200 in the conversation visualiser 300 in which a comment 1205 of a discussion is being viewed by a user in the comment player 400. The discussion comprises a number of threads 1210 with a plurality of comments 1215 which are related to a respective thread 1210. The comment illustrated with a box 1220 is the comment currently being viewed by the user. The comment being played may be associated with an image 1225 of the author of the comment, a comment length 1230 and a number of votes and/or likes/dislikes 1235. The comment and discussion both preferably comprise a title, 1240 and 1245 respectively. The reward that can be obtained by closing a particular thread is listed alongside each thread 1250.

Optionally, the system allows for a conversion of audio to text, such that comments may be read rather than only listened to or watched. This may increase the efficiency for a member of a meeting to catch up to the most recent comments of a meeting and may be used for search engine input. It will be appreciated that if an audio comment is converted to text that the audio may still be listened to if preferred by a user.

In yet a further embodiment, the system may have a maximum number of people allowed for a single meeting, however if more than a maximum number of allowable users are proposed for a meeting, the meeting may be split into two or more meeting groups. This may allow the two or more meeting groups to individually come up with a solution to an issue at a meeting. The individual solutions for a meeting may then be merged into a further meeting in which only the most active meeting members from respective meetings or the members of the meetings who provided solutions or summaries are invited to attend. This may allow for a consolidation of ideas and reasoning for different solutions. It will be appreciated that if a further meeting is started that the previous meeting history may be accessed by other members of a meeting. This may allow members of a meeting to view and understand the reasoning behind a proposed solution for an issue without further explanation from the remaining members of the respective original meetings.

This type of meeting progression may be a ‘tournament’ meeting structure which may be used by regulatory bodies, governments, polling, researchers or for other applications where a large sample size is required. A tournament meeting may allow only the members of the meetings to progress if their contributions are deemed to be supported by the majority of the members of the meeting. The ‘winners’ of the meetings may progress to at least one subsequent meeting and so on until a final meeting is generated based on the previous winners and consensus proposals of the tournament meetings. This should allow the most valuable comments and solutions to an issue to be progressed to the end of a sample group such that key issues and solutions can be discussed. This may be of particular importance for government bodies to ascertain the concerns and/or proposed solutions of the public. Further, this may assist with political parties obtaining the core concerns of their delegates more cost effectively and with a recorded history of reasoning.

Optionally, the members of the meeting who did not progress, herein referred to as the ‘observers’, may be requested to ratify proposed solutions such that the solutions proposed cannot be easily manipulated by a small group of meeting member winners. This allows the observers to retain a small portion of decision making such that the overall sample group can be considered, which is of particular importance with regards to political usage. This also provides a further level of security for meetings as the solutions are less likely to be generated from influenced or corrupt meeting member winners. A threshold for ratifying a solution may be applied such that if a solution receives less than a predetermined percentage of the observers in agreement or in support of a proposed solution, the solution is not ratified. It will be appreciated that no solutions may be ratified if the observers do not agree with the proposed solutions.

In a further embodiment, the system provides for an online discussion with a low quality of coarsely pixelated or abstracted video comments. The low quality of the video may convey the facial expressions, tones and other emotional responses of a real time conversation, which may overcome a number of problems with purely text based messaging, such as email or instant messaging without the invasion of privacy associated with quality video. The comments are preferably able to be played or viewed multiple times and/or at a user's leisure. This removes the requirement for a resolution or proposed solution for an issue to be solved by the end of a meeting without the opportunity of more in depth though for ramifications of a proposed solution, for example the cost effectiveness or feasibility of a proposed solution or resolution. Preferably, a meeting and/or discussion can be held not in real time, such that members of a meeting can view the meeting at differing times.

The system preferably allows a table or graph to be constructed that may visually assist members of a meeting to see the different tracks and branches generated to quickly make sense of the discussion and know how close the meeting is to resolution and know which threads and related issues to focus attention to progress toward a resolution. Additionally, as users have the ability to review previous comments made during a meeting the user can review the foundations for their own reasoning. This approach to meetings may reduce the potential for resolutions or potential solutions to have flawed logic reasoning.

In addition, the system may provide a member of a meeting the option of prompting how to adequately word or address a comment for the meeting, such that clearer and concise comments will be encouraged from the members of the meeting. The members of the meeting will also have the opportunity to see where the meeting is headed based on the comments made and newer comments which are generated by the members of the meeting.

The table representation of the meeting may also make users feel like they are in a game, which may nudge a member of a meeting to participate in a conversation. A ‘nudge’ is a concept in behavioural science, political theory and economics which argues that positive reinforcement and indirect suggestions to try to achieve non-forced compliance can influence the motives, incentives and decision making of groups and individuals, at least as effectively—if not more effectively—than direct instruction, legislation, or enforcement. The ‘game’ type aspects of the system may lie in the visual construction of the meeting, in which the initial object of the meeting is to expand the threads of questioning and explore proposed solutions to threads. The system may further entice members of the system to then narrow down or rule out at least one potential solution generated for a thread, such that the threads are collapsed to fewer and fewer potential solutions until a potential resolution is found for the meeting. The potential resolution may be accompanied by a summary or closure comment describing why the resolution was the desired approach to a thread of discussion during a meeting. This may assist with quickly identifying but also retaining a record of the risks associated with alternative proposed solutions, and the benefits of selecting the current resolution.

The system may also provide a second ‘logical’ view to show how each thread of conversation affects at least one proposal or context item. This is to say that each thread may be affected by a proposed solution (or context item) if the proposed solution is supported or rejected. For example, if a proposed solution for a thread were to sell an asset to generate funds, another thread proposed a solution in which said asset were used to produce more funds (as opposed to selling) cannot exist if the asset is sold, which may be illustrated to member of a meeting. In this example, a user may visually see the impact of making a decision for one thread on other proposed solutions, which may produce fewer mistakes and eliminate uncertainty when forming a decision for a proposed solution. This may allow conversations to be easily digested by a member of a meeting which is accompanied by reasoning for and against a proposed solution.

In yet a further embodiment, the impact on at least one thread or discussion or proposal or other context item may be visually displayed to a user of the system when they interact with a decision option. For example, if a user were to hover a curser over the option to vote for closure of a comment in a particular discussion, other proposals dismissed by the comment may be illustrated with a strikethrough to illustrate that these options will be eliminated if the proposed comment is accepted. It will be appreciated that any illustrative means may be adapted for use by the system.

In another embodiment, at least one filter, search option, or control may allow a user to more quickly find a desired thread or comment. This may further reduce the time required to catch up on a meeting or may allow for a user to quickly find a relevant solution they wish to accept or reject. Other options may be provided by the system such that the application may allow a member of a meeting or a user of the system to more easily skip or navigate a meeting conversation thread or comments. For example, the system may allow a user or member of a meeting to play an influential clip or comment, listen to influential comments for a proposal or play a comment that a currently viewed comment is responding to. It will be appreciated that a proposal may be directly linked to comments which for the basis for a proposed solution or proposed resolution, which may further reduce the time to catch up on a meeting or consume meeting content relatively more quickly. It will be appreciated that a user of the system may also be a member of a meeting.

At least one rule may be adapted to control the discussion structure, such as the allowable speaking time, allocate a sub-group of people and/or meeting members and/or users of the system, a threshold of votes which is to be considered a consensus, or sequential phases. A sequential phase may be, for example, an introduction, a consideration of evidence, a question and answer (Q&A), proposals (which may include proposed solutions or proposed resolutions), brainstorming proposals, and debate of options or proposals.

In at least one embodiment, the system is adapted to treat speaking time or comment length or number of comments as a currency. The available speaking time is allocated to members of a meeting in which there is a market for time that incentivises desired behaviours. Desired behaviours are typically behaviours which consolidate the discussion so far and progress a meeting in a desirable direction such as towards a proposal resolution or proposed solution or consensus position relating to an issue raised in a meeting or discussion. Such behaviours may be more likely to encourage members of a meeting to make insightful, influential and useful summarising comments which provide a more productive meeting. This may further encourage members of a meeting to avoid proposing new solutions or generating new discussion threads which may clutter or distract the meeting. The “market” generated by the system encourages members to consolidate a discussion before the discussion expands more than a desired threshold as the resources to make comments are reduced as system currency is spent and taxed. As such, users are more likely to grasp important points in the discussion before expending their system currency. For example, if the meeting must be resolved in 2 hours of talking time and new comments are prohibitively taxed when currently open threads exceed 20 minutes in length, this may encourage users to continually consolidate the important points of the meeting and put extra thought into their comments so that their remaining time is used to best effect.

Comments in the general meeting may also be joint comments made by sub-groups or other associated groups of the meeting after their private threads arrive at a consensus. This mechanic may allow the general meeting to be scaled to a larger number of participants without cluttering the general meeting with too many comments and an unmanageable length of audio/video/text content. The market for comments is arranged such that comments in a general meeting are relatively expensive compared to those within a sub-group. As the general meeting comments are typically more expensive compared to that of a sub-group a comment for a general meeting may be generated from a sub-group consensus to reduce costs and reflect at least one outcome from a sub-group.

In yet a further embodiment, the system allows at least a portion of currency to be traded or borrowed to a member of a meeting. Borrowing or giving a currency to another member of a meeting may allow them to generate a new comment if their currency is expended. A member of a meeting may have their currency expended faster than others if they are continually providing reasoning and comments for a meeting in response to other members of a meeting. This may allow a summary of a thread to be made, such that the currency earned by the summariser (if a consensus is made) may be used to pay back the borrower with or without interest. Other terms may be associated with borrowing currency to another member of a meeting.

In a further embodiment, the system allows a total speaking time of the discussion to be distributed to members of a meeting which provide constructive comments to be rewarded if they are not the ones to make a summary. The reward for constructive comments may be allocated democratically by the other members of the meeting such that members of the meeting with constructive comments may be allowed to continue to make such comments. It will be appreciated that meeting currency may be transferred to other meetings if the system is adapted to allow such a movement of currency. A vote may be used to whenever a judgement of content or a proposal is required for a meeting. However, the voting mechanic of the system provides that a vote may only be won when a near consensus or consensus is achieved. Voting for comments may be changed during a discussion which reflects the changing views of the members of a meeting in light of new comments and/or evidence, which may also assist with members of a meeting to reach a proposed solution or resolution for a meeting.

A further result of the market mechanics and voting as described in this system is that it is possible to statistically identify creative and valuable consensus-building. This may more easily identify members of a meeting which have management skills, or other desirable skills from a group of people. The more creative and consensus-building members of a meeting may receive more time to speak in the discussion and “rise to the top” in a quantifiable manner as a result of specific contributions to a discussion or meeting. As such, the system may be adapted for identification of leaders and creative persons which may be more suited to higher level or management roles in an organisation or business.

Optionally, the meeting may allow at least one moderator to assess comments and threads. The moderator may have the capacity to ban meeting members, restrict access to users of the system, delete comments, edit comments or any other predetermined administrative function. A moderator may diffuse arguments or disputes which arise in a meeting or conversation, which may be achieved by fining or adjusting the taxes on users who are unjustifiably negative or disruptive to a meeting. Further, as the system may be adapted to analyse or assess content uploaded by a user to support or reject a proposed solution, the system may penalise the user who supplied the data. For example, a user may upload a document which states that the earth is flat for their argument, however the system or moderator may deem that such a statement is misleading or false based on substantial evidence and may heavily tax or otherwise apply a warning or other deterrent for supplying documentation which has a high probability of being false or misleading. Other statements which may incur a heavy tax may include; slanderous comments, spurious comments, inappropriate statements, mischievously reporting other meeting members to the moderator or the like. Additionally, the moderator role may be filled by a sub-group of the meeting members or other users, either nominated or randomly selected, and their determinations made using the standard comment, voting and consensus-building mechanics that comprise the system.

In yet a further embodiment, the system may be an application which allows for a conversation to be embedded as an “app-sized box” in an external website which the conversation is about. For example, the system may be used in replacement to a standard text-based comment section on an online news article, allowing the readers to discuss the article in a much more interactive and productive way. The system may also be adapted to read the existing text-based comments for an online news article and adapt the text such that it can be displayed in a table form or displayed in a form generated by a discussion template. This may allow a person or reader interested in a particular discussion in the comment section of the article to easily read all comments in relation to a thread while excluding comments which are not relevant. Further, the system may also be adapted for an audio-only mode which may be suitable for car trips or the like. The audio-only mode may play comments which have not been listened to in a logical order, with appropriate audio snippets to orient the comment in the discussion and voice commands to tag something for later review or response. It will be appreciated that at least a part of a thread may be played in audio-only which comprises both listened comments and comments which have yet to be listened to in a predefined order. It will be appreciated that a “thread” may optionally also be referred to as a “topic” in at least one embodiment.

In yet a further embodiment, the system may allow a meeting to occur not in real time, such that users of the system can catch up on the comments and make comments when they are available between other tasks. This may be advantageous as this allows a meeting to progress regardless of busy schedules. The system preferably allows comments to be uploaded via an internet connection regardless of the physical device location that the user is using. In yet a further embodiment, the system may allow for a real time meeting that uses a combination of automatic inputs and manual inputs to identify the user making the comment and other key metadata required for the conversation structure and visualisation. An example of an automatic input may be voice or device identification to identify the user making a comment, a key word search, or artificial intelligence processing on comment text after voice to text conversion to determine other metadata. An example of manual inputs could be use of the structure questionnaire 900 during or after the meeting session to modify metadata on comments that appear in the meeting with ‘best-guess’ or default selections.

In at least one embodiment, a user may also be a member of a meeting. The system may also remove the need for a facilitator to be involved with a meeting to ensure that a meeting is progressed or remains on track.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

The claims defining the invention are as follows:

1. A system for managing a meeting, the system comprising;
a server adapted for storing at least one data set;
the server in communication with at least one user device, in which the system is adapted to receive at least one input from at least one user for upload to the server;
the input generates at least one further data set which is assigned to at least one thread of a discussion automatically by the server in which each of the at least one threads relate to a respective discussion;
the at least one thread comprises at least one comment; and
wherein the system is adapted to output a graphical display for at least a portion of the discussion based on the at least one input from the at least one user device, such that when a further thread for a discussion is input, the system generates a further thread for the discussion.

2. The system as claimed in claim 1, wherein the input from the at least one user device comprises at least one of; a further comment, a like, a dislike, and a vote.

3. The system as claimed in claim 1, wherein at least one of the comment and the further comment comprises at least one of; audio data, video data, text data, images data, at least one document data set, and a web address.

4. The system as claimed in claim 1, wherein each comment comprises at least one context item.

5. The system as claimed in claim 1, wherein the system is adapted to generate at least one track for a thread when a comment is made by a user for a discussion.

6. The system as claimed in claim 1, wherein the discussion is at least one of the group; a meeting, a conference, a poll, a forum and a convention.

7. The system as claimed in claim 1, wherein the system uses a template to assign data for the graphical display of at least a portion of the discussion.

8. The system as claimed in claim 7, wherein the template is a custom template generated by at least one user of the system.

9. The system as claimed in claim 1, wherein the system generates a value associated with a comment.

10. The system as claimed in claim 9, wherein the value is at least one of a tax and a reward, which is generated based on at least one of; a number of comments in the discussion, a length of the discussion and a level of agreement in the discussion.

11. The system as claimed in claim 10, wherein a context item is a data set associated with at least one comment which comprises data which is related to at least one of a goal, a proposal, evidence and a meeting specific data set.

12. A system for managing a discussion, the system comprising;
a data set stored on a sever relating to a discussion for an issue, in which the discussion comprises at least one thread;
the at least one thread comprising at least one comment generated by at least one user of the system; and
wherein the system is adapted to output a graphical display for at least a portion of the discussion based on the at least one input from the at least one user device, such that when a further thread of discussion is input, the system generates a further thread for the further thread of discussion.

13. The system as claimed in claim 12, wherein the system generates at least one of a virtual tax and a virtual reward for generating a comment.

14. The system as claimed in claim 13, wherein at least one of a virtual tax and a virtual reward is generated based on at least one context item associated with the discussion.

15. The system as claimed in claim 14, wherein a comment can be associated with at least one context item.

16. The system as claimed in claim 12, wherein the system provides an incentive to generate a constructive comment for a discussion.

17. The system as claimed in claim 12, wherein a comment comprises at least one of audio data, video data, text data, images data, at least one document data set, and a web address.

18. The system as claimed in claim 12, wherein the at least one user of the system is provided with an incentive to generate a summary for at least a part of the discussion.

19. The system as claimed in claim 18, wherein the incentive is at least one of;
currency, virtual currency, talk time, number of comments available to be generated or access to a further meeting.

20. The system as claimed in claim 1, wherein the discussion is not in real time.
